(19) United States
(12) Patent Application Publication
(10) Pub. No.: US 2017/0062003 A1
(43) Pub. Date: Mar. 2, 2017

(54) MAGNETIC DISK DEVICE AND DEFECT DETECTION METHOD

(71) Applicant: Kabushiki Kaisha Toshiba, Tokyo (JP)

(72) Inventor: Ryoichi Amano, Kamakura Kanagawa (JP)

(21) Appl. No.: 14/967,014

(22) Filed: Dec. 11, 2015

Related U.S. Application Data
(60) Provisional application No. 62/209,751, filed on Aug. 25, 2015.

(51) Int. Cl. G11B 20/18

(52) U.S. Cl. CPC G11B 20/1816

(57) ABSTRACT

A magnetic disk device according to an embodiment includes a disk including a data area, a head configured to read and write data from and to the data area, and a controller configured to determine under a first condition whether the data area includes a defect, and to determine, under a second condition of a higher defect detection sensitivity than the first condition, whether a first area around a first defect area includes a defect, when detecting the first defect area under the first condition.

### CROSS-REFERENCE TO RELATED APPLICATIONS

This application claims the benefit of U.S. Provisional Application No. 62/209,751, filed Aug. 25, 2015, the entire contents of which are incorporated herein by reference.

### FIELD

Embodiments described herein relate generally to a magnetic disk device and a defect detection method.

### BACKGROUND

When a magnetic disk device is manufactured, disk defect detection is performed, wherein defects, such as bumps (drops-in), dents (drops-out) and scratches, existing in a storage area of a magnetic disk are detected, and the detected defects are registered in respective sectors where the detected defects have occurred.

In the magnetic disk device, since a bump or dent is relatively large in a central portion of each defect, the center of each defect can be detected as a defect. In contrast, at a start or end portion of each defect, a bump or dent is relatively small, and hence the start or end portion of each defect may not be detected as a defect if the same determination criterion as that for the center portion is employed. A small defect that may occur at, example, the start or end portion of a defect may grow into a later-detected defect sector or a bad sector because of the influence of, for example, a slight characteristic degradation of a head element. Further, when the small defect grows into the later-detected defect sector or the bad sector, the magnetic disk device may retry several times in the same area on a disk during reading recorded data. This may involve reduction of read performance or lost of recorded data.

### BRIEF DESCRIPTION OF THE DRAWINGS

FIG. 1 is a block diagram showing configuration of a magnetic disk device according to a first embodiment.

FIG. 2 is a schematic diagram showing an example of a method of detecting a signal waveform, using a defect scanning function.

FIG. 3A is a diagram showing a size example of a scan window for detecting defects.

FIG. 3B is a diagram showing examples of determination criteria for detecting defects.

FIG. 4A is a diagram showing examples of defects in a magnetic disk.

FIG. 4B is a diagram showing examples of periods of changing the determination criteria for detecting defects.

FIG. 5 is a flowchart showing a method of detecting a defect in the magnetic disk device of the first embodiment.

FIG. 6 is a flowchart showing a method of detecting a defect in a magnetic disk device according to modification 1 of the first embodiment.

FIG. 7 is a flowchart showing a method of detecting a defect in a magnetic disk device according to modification 2 of the first embodiment.

FIG. 8 is a flowchart showing a method of detecting a defect in a magnetic disk device according to modification 3 of the first embodiment.

FIG. 9 is a flowchart showing a method of detecting a defect in a magnetic disk device according to a second embodiment.

### DETAILED DESCRIPTION

In general, according to one embodiment, a magnetic disk device comprises: a disk including a data area; a head configured to read and write data from and to the data area; a controller configured to determine under a first condition whether the data area includes a defect, and to determine, under a second condition of a higher defect detection sensitivity than the first condition, whether a first area around a first defect area includes a defect, when detecting the first defect area under the first condition. Embodiments will be described with reference to the accompanying drawings.

### First Embodiment

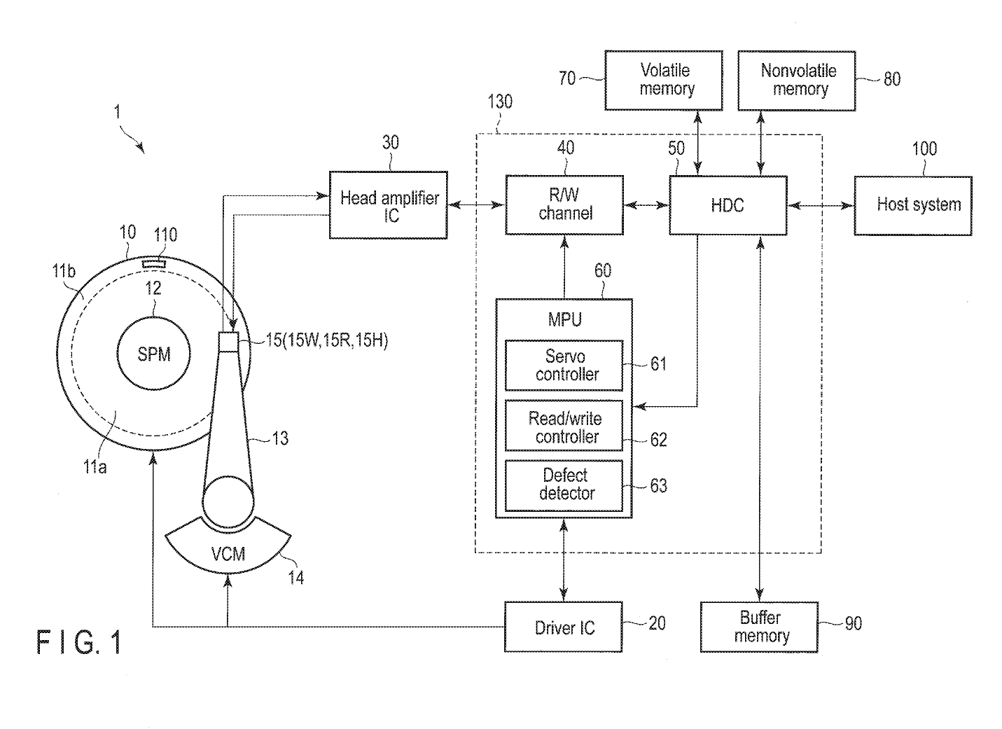

FIG. 1 is a block diagram showing configuration of a magnetic disk device according to a first embodiment.

A magnetic disk device 1 comprises a head-disk assembly (HDA), described later, a driver IC 20, a head amplifier integrated circuit (hereinafter, referred to as the head amplifier IC) 30, a volatile memory 70, a nonvolatile memory 80, a buffer memory (buffer) 90, and a system controller 130. Further, the magnetic disk device 1 is connected to a host system (host) 100.

The HDA comprises a magnetic disk (disk) 10, a spindle motor (SPM) 12, an arm 13 with a head 15, and a voice coil motor (VCM) 14. The disk 10 is rotated by the spindle motor 12. The arm 13 and the VCM 14 constitute an actuator. The actuator moves the head 15 on the arm 13 to a particular position on the disk 10 in accordance with the rotation of the VCM 14. Two or more disks and two or more heads 15 may be employed.

The disk 10 has a data area, to which a recording area 11a that can be used by a user, and a system area 11b for storing data necessary for system management, are allocated.

A defect management list 110 includes a P list (primary list) and a G list (grown list). The defect management list 110 may be stored in a volatile memory 70, described later, a nonvolatile memory 80, etc.

The P list is used to manage defect sectors detected by defect scanning performed before the shipment of the magnetic disk device 1. The P list is generated based on, for example, an address map of a data structure associated with the disk 10.

The G list is used to manage defect sectors detected by sector access after shipment of the magnetic disk device 1 (such sectors will hereinafter be referred to as later-detected defect sectors). The G list shows correspondence relationship between logical block addresses (LBA) or physical addresses of the later-detected defect sectors and substitutive sectors used in place of such the defect sector. As the substitutive sectors, sectors in a substitutive area secured on the disk 10 are used.

The head 15 comprises a write head 15W, a read head 15R and a heater element 15H, which are mounted on a slider as a main body. The read head 15R reads data from a data track on the disk 10. The write head 15W writes data to the disk 10. The heater 15H generates heat when power is supplied thereto, thereby thermally expands a part of the head 15. That is, the heater 15H adjusts flying height of the head 15 with respect to the surface of the disk 10.

The driver IC 20 controls to drive of the SPM 12 and the VCM 14 under control of the system controller 130 (more specifically, an MPU 60 described later).

The Head amplifier IC 30 has a read amplifier and a write driver. The read amplifier amplifies a read signal read by the read head 15R, and transmits it to a read/write (R/W) channel 40. The write driver supplies the write head 15W with a write current corresponding to write data output from the R/W channel 40.

The volatile memory 70 is a semiconductor memory from which saved data will be lost when the supply of power thereto is interrupted. The volatile memory 70 stores, for example, data required for processing in each part of the magnetic disk device 1. The volatile memory 70 is, for example, a synchronous dynamic random access memory (SDRAM).

The nonvolatile memory 80 is a semiconductor memory that holds saved data even if the supply of power thereto is interrupted. The nonvolatile memory 80 is a flash read-only memory (FROM), for example.

The buffer memory 90 is a semiconductor memory that temporarily holds, for example, data to be transmitted between the disk 10 and the host system 100. The buffer memory 90 may be provided integral with the volatile memory 70 as one body. The buffer memory 90 is, for example, a dynamic random access memory (DRAM), a static random access memory (SRAM), a ferroelectric random access memory (FeRAM), or a magnetoresistive random access memory (MRAM).

The system controller (controller) 130 is realized using a large-scale integrated circuit (LSI), called System-on-a-Chip (SoC), which comprises, for example, a plurality of elements integrated on one chip. The system controller 130 comprises the read/write (R/W) channel 40, a hard disk controller (HDC) 50, and a microprocessor (MPU) 60.

The R/W channel 40 performs signal processing of read and write data. The R/W channel 40 has a circuit that detects a change in the amplitude of a signal supplied from the head amplifier IC 30. Using this circuit, the R/W channel 40 executes defect scanning to detect defects of the disk 10, such as a dent or drop-out, a bump or drop-in, and a scratch (i.e., the R/W channel 40 has a defect scanning function). By this defect scanning, the R/W channel 40 can detect variation in the amplitude of a signal waveform due to unevenness of the surface of the disk 10 that results from, for example, lack of a magnetic film during a manufacturing process. In a defect inspection process in the manufacturing process, the R/W channel 40 detects initial defects in the disk 10, using the defect scanning function. A sector (defect sector) from which a defect was detected, or a servo frame number associated with the sector, is registered in a defect management list.

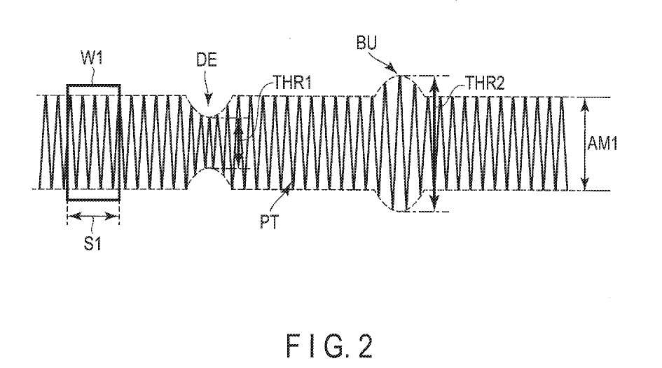

FIG. 2 is a schematic diagram, showing an example of a signal-waveform detection method using the defect scanning function. The output of Head amplifier IC shown in FIG. 2 will hereinafter be referred to as a slice.

The R/W channel 40 detects a defect, using a tone-scan defect detection scheme (hereinafter, referred to as the tone-scan scheme) as an example of the defect scanning function. In this tone-scan scheme, the R/W channel 40 writes a uniform data pattern PT of a constant frequency to a cylinder (truck) as an inspection target, sets the read channel in a defect scanning model, and reads the written data pattern PT. If the amplitude of the signal waveform of the read data pattern PT shows a fluctuation exceeding a set threshold (hereinafter, a threshold), the R/W channel 40 supplies the HDC 50, the MPU 60, etc., with a flag indicating that the amplitude exceeds the threshold. The R/W channel 40 writes position data, such as the servo frame number of a sector in which a fluctuation exceeding the threshold is detected, to a recording medium, such as the disk 10, the volatile memory 70, or the nonvolatile memory 80. The uniform data pattern PT of a constant frequency is a pattern whose magnetization reverse time is 2T (hereinafter, referred to as the 2T pattern), such as 11001100 . . . .

When the R/W channel 40 detects the uniform data pattern PT by the tone-scan scheme, it can adjust detection sensitivity associated with defects by changing the size S1 of the detection range called a scanning window W1. The size S1 of the scanning window W1 is the width of the scanning window W1 extending along the wavelength of the uniform data pattern PT. If the size S1 of the scanning window W1 is reduced, the detection sensitivity of the R/W channel 40 associated with defects is enhanced. In this case, however, the possibility of excessively detecting, for example, noise also increases. The detection sensitivity associated with defects may be also referred to simply as “detection sensitivity” or “defect detection sensitivity.”

The R/W channel 40 reads a uniform data pattern PT of an envelope waveform as shown in FIG. 2. The R/W channel 40 detects the waveform DE of a dent and the waveform BU of a bump in the read uniform data pattern PT. For example, the R/W channel 40 detects the waveform DE of a dent as an attenuating slice (THR1), and the waveform BU of a bump as an amplified slice (THR2), with respect to the amplitude (slice) AM1 of an envelope waveform having a uniform data pattern PT.

In association with the amplitude of the dent waveform DE, the R/W channel 40 registers, as a defect sector (bad sector) in the defect management list, a sector on the disk 10 wherein an amplitude smaller than a threshold (first threshold) set for a signal waveform amplitude for detecting a dent on the disk 10 is detected.

Similarly, in association with the amplitude of the bump waveform BU, the R/W channel 40 registers, as a defect sector (bad sector) in the defect management list 110, a sector on the disk 10 wherein an amplitude smaller than a threshold (second threshold) set for a signal waveform amplitude for detecting a bump on the disk 10 is detected. The first and second thresholds may be collectively referred to as the threshold.

Returning to FIG. 1, the HDC 50 controls data transfer between the host system 100 and the R/W channel 40 in accordance with instructions from the MPU 60.

The MPU 60 is a main controller for controlling each part of the magnetic disk device 1. The MPU 60 controls the VCM 14 via the driver IC 20, thereby performing servo control of positioning the head 15. Further, the MPU 60 controls a write to the disk 10, and performs control of selecting the storage destination of write data transferred from the host system 100.

The MPU 60 comprises a servo controller 61, a read/write controller 62 and a defect detector 63. The MPU 60 performs the processing for these elements using firmware.

The servo controller 61 performs position control of the head 15. The servo controller 61 performs position control of the head 15 in accordance with, for example, instructions from the defect detector 63, described later. The servo controller 61 can also perform position control of the head 15 with reference to the defect management list 110.

The read/write controller 62 controls read/write operation of the head 15. The read/write controller 62 controls read/write operation of the head 15, referring, for example, to the defect management list 110.

The defect detector 63 controls the head 15 and the R/W channel 40 to perform defect scanning of detecting a defect sector. Upon detecting a defect, the defect detector 63 registers a sector with the detected defect in the defect management list 110. The defect detector 63 performs defect scanning, with the flying height maintained constant using the heater 15H.

Moreover, the defect detector 63 detects a smaller defect (hereinafter, referred to as a small defect) than that detected by normal defect scanning executed in a defect inspection process (hereinafter, referred to simply as the inspection process), and registers the small defect in the defect management list 110. In order to detect a small defect, the defect detector 63 can perform two or more defect scannings for the same cylinder. The term “small defect” denotes a small dent or bump that occurs at, for example, the start or end portion of a defect.

Therefore, the defect detector 63 performs a defect scanning not only on the central area of a defect where the output waveform amplitude exhibits significant fluctuation, but also on end areas of the defect where it exhibits small fluctuation. If in the inspection process, a defect is detected, the defect detector 63 registers, in the defect management list 110, the sector (or servo frame) number of at least one defect sector (the at least one defect sector will hereinafter be referred to as a defect sector [group]) where a normal defect is detected. In the inspection process, the defect detector 63 may temporarily store the sector number corresponding to the normal defect in another recording medium, such as the volatile memory 70. The term “defect sector group” denotes a defect area including at least one defect sector.

When detecting a small defect, the defect detector 63 acquires the sector numbers of a defect sector group recorded in the defect management list 110 or in a recording medium. In this case, the defect detector 63 changes determination criteria including a reference value (threshold) for determining the existence of a defect, in order to detect the small defect. For instance, the defect detector 63 changes current determination criteria including detection sensitivity for detecting a normal defect, to subsequent determination criteria including a higher detection sensitivity. Referring to the sector numbers of the defect sector group, the defect detector 63 performs defect scanning on a sector (hereinafter, referred to as the adjacent sector) radially or circumferentially adjacent to the defect sector group. If receiving, in a certain sector on the disk 10, a signal that satisfies the above-mentioned subsequent determination criteria, the defect detector 63 determines that the certain sector has a small defect.

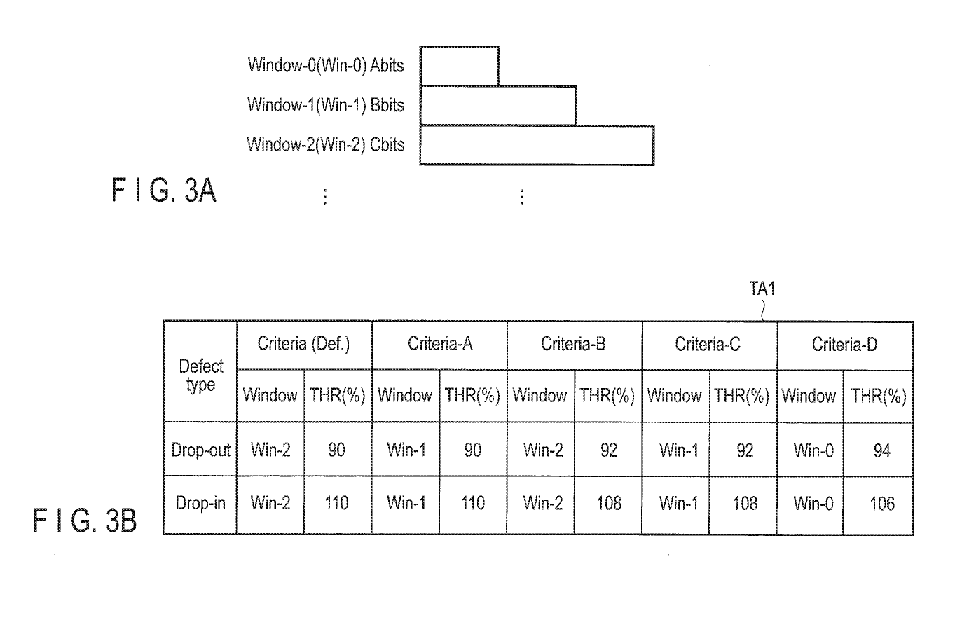

FIG. 3A shows examples of the sizes S1 of scanning windows W1 for detecting a defect, and FIG. 3B shows examples of determination criteria for detecting a defect.

The defect detector 63 holds data indicating the sizes S1 of the scanning windows W1, evaluated in advance, in a recording medium, such as the system area 11b, the volatile memory 70 or the nonvolatile memory 80.

In FIG. 3A, the detection sensitivity is increased in an order of Window-0 (Win-0) of A bits, Window-1 (Win-1) of B bits and Window-2 (Win-2) of C bits.

As shown in FIG. 3B, the defect detector 63 sets some defect determination criteria, evaluated in advance, as table TA1 in a recording medium, such as the system area 11b, the volatile memory 70 or the nonvolatile memory 80.

In FIG. 3B, Criteria (Def.), Criteria-A, Criteria-B, Criteria-C, and Criteria-D indicate the determination criteria for detecting a defect. In table TA1, the “Drop-out” row shows determination criteria associated with dents, and the “Drop-in” row shows determination criteria associated with bumps. The “Window” column shows the sizes S1 of scanning windows. The THR (%) column shows thresholds of defect detection. THR (%) of the “Drop-out” row shows the first threshold, and THR (%) of the “Drop-in” row shows the second threshold. THR (%) shows the ratio (%) of each slice amplitude to the amplitude AM1 of the uniform data pattern PT shown in FIG. 2, assuming that the amplitude AM1 is regarded as 100%.

In FIG. 3B, determination criteria “Criteria (Def.)” are applied to detection of a normal defect. Determination criteria “Criteria-A,” “Criteria-B,” “Criteria-C” and “Criteria-D” are applied to detection of a small defect. Determination criteria “Criteria-C” and “Criteria-D” are set to higher detection sensitivities higher than those of determination unit criteria “Criteria-A” and “Criteria-B,” thereby enabling smaller defects to be detected than in the case of using the latter criteria.

For instance, THR (%) of a dent corresponding to Criteria (Def.) shown in FIG. 3B is 90% with respect to the amplitude AM1 of the uniform data pattern PT. That is, when determination criteria “Criteria (Def.)” are used, the defect detector 63 performs defect scanning with Win-2. When detecting a dent waveform of an amplitude that is 90% of the amplitude AM1 of the uniform data pattern PT, the defect detector 63 determines that the dent waveform is of a normal defect. At this time, the defect detector 63 registers, in the defect management list, the sector number of a sector of the disk 10 in which a dent determined to be a normal defect is detected.

For example, in FIG. 3B, THR (%) as Criteria (Def.) for a bump is 110% with respect to the amplitude AM1 of the uniform data pattern PT. That is, when determination criteria “Criteria (Def.)” are used, the defect detector 63 performs defect scanning with Win-2. When detecting a bump waveform of an amplitude that is 110% of the amplitude AM1 of the uniform data pattern PT, the defect detector 63 determines that the bump waveform is of a normal defect. At this time, the defect detector 63 registers, in the defect management list, the sector number of a sector of the disk 10 in which a bump determined to be a normal defect is detected.

(Method of Detecting a Small Defect)

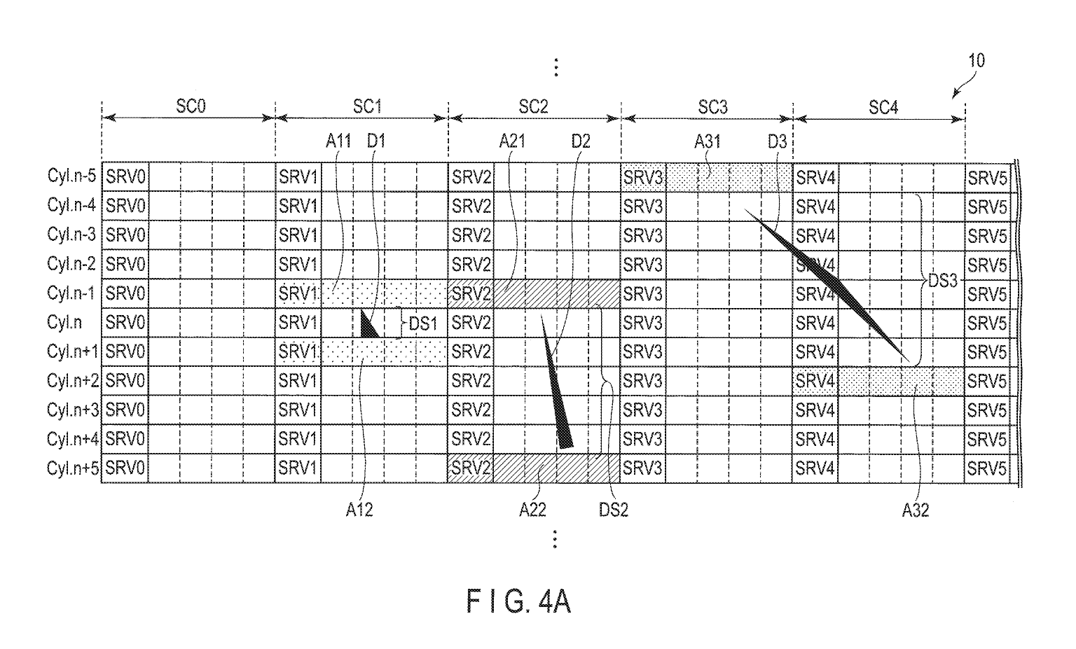

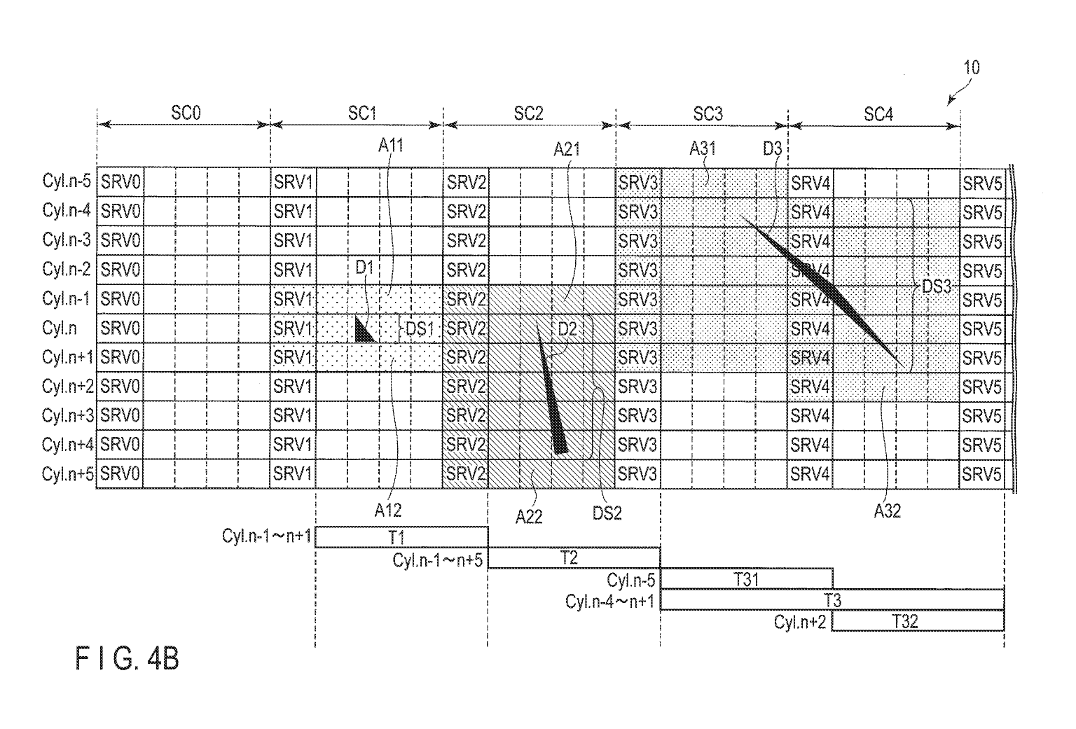

FIG. 4A is a schematic diagram showing examples of defects in the disk 10, and FIG. 4B is a diagram showing examples of periods in which the determination criteria for detecting defects are changed.

In FIGS. 4A and 4B, Cyl.n, Cyl.n−1, Cyl.n−2, Cyl.n−3, Cyl.n−4 and Cyl.n−5 indicate respective cylinders of the disk 10. Similarly, Cyl.n+1, Cyl.n+2, Cyl.n+3, Cyl.n+4, and Cyl.n+5 also indicate respective cylinders of the disk 10. Cylinders Cyl.n−1 to Cyl.n−5 and cylinders Cyl.n+1 to Cyl.n+5 are arranged symmetrically with respect to cylinder Cyl.n. In FIGS. 4A and 4B, assume that the cylinder Cyl.n−1 to Cyl.n−5 side is set as a radially outside (hereinafter, referred to simply as the outside) with respect to cylinder Cyl.n, and the cylinder Cyl.n+1 to Cyl.n+5 side is set as a radially inside (hereinafter, referred to simply as the inside).

SC0, SC1, SC2, SC3 and SC4 denote respective sectors on the disk 10. Sectors SC0 to SC4 include servo data (servo frames) SRV0, SRV1, SRV2, SRV3 and SRV4, and user areas, respectively. The direction from SC0 to SC4 is set as a circumferential direction.

D1, D2, and D3 denote normal defects detected in the inspection process. Defect D1 is detected in sector SC1 of cylinder Cyl.n. Sector SC1 of Cyl.n where defect D1 is detected will hereinafter be referred to as defect sector DS1. Defect D2 extends in sectors SC2 ranging from cylinder Cyl.n to cylinder Cyl.n+4. A plurality of sectors SC2 ranging from cylinder Cyl.n to cylinder Cyl.n+4, where defect D2 is detected, will hereinafter be referred to as defect sector group DS2. Similarly, defect D3 circumferentially extends from sector SC3 to sector SC4 and radially extends from cylinder Cyl.n−4 to cylinder Cyl.n+1. A plurality of sectors SC3 and SC4 ranging from cylinder Cyl.n−4 to cylinder Cyl.n+1, where defect D3 is detected, will hereinafter be referred to as defect sector group DS3.

Adjacent sector A11 is sector SC1 of Cyl.n−1. Adjacent sector A11 adjoins the outside of defect sector DS1 where defect D1 is detected. Adjacent sector A12 is sector SC1 of Cyl.n+1. Adjacent sector A12 adjoins the inside of defect sector DS1.

Adjacent sector A21 is sector SC2 of Cyl.n−1. Adjacent sector A21 adjoins the outside of defect sector group DS2. Adjacent sector A22 is sector SC2 of Cyl.n+5. Adjacent sector A22 adjoins the inside of defect sector group DS2.

Adjacent sector A31 is sector SC3 of Cyl.n−5. Adjacent sector A31 adjoins the outside of defect sector group DS3. Adjacent sector A32 is sector SC4 of Cyl.n+2. Adjacent sector A32 adjoins the inside of defect sector group DS3.

In FIG. 4B, T1 denotes a period in which determination criteria should be changed in adjacent sectors A11 and A12 and defect sector DS1. T2 denotes a period in which determination criteria should be changed in adjacent sectors A21 and A22 and defect sector group DS2. T3 denotes a period in which determination criteria should be changed in defect sector group DS3. T31 denotes a period in which determination criteria should be changed in adjacent sector A31, and T32 denotes a period in which determination criteria should be changed in adjacent sector A32. In FIG. 4B, assume that sectors SC0 to SC4 are scanned in this order in accordance with the rotation of the disk 10.

After detecting a normal defect in the inspection process, the defect detector 63 changes determination criteria between adjacent sectors adjacent to the outside and inside of a defect sector group, and executes defect scanning for detecting a small defect. Further, during defect scanning in one cylinder (track), the defect detector 63 refers to, for example, the sector number of a defect sector, and changes determination criteria when reading a servo frame.

A description will be given of an example of a defect scanning method, employed in the defect detector 63, of detecting a small defect in radially adjacent sectors in FIG. 4A.

For instance, in FIG. 4A, after the inspection process, the defect detector 63 changes determination criteria from Criteria (Def.) to Criteria-A in adjacent sector A11, and performs defect scanning therein. The defect detector 63 moves the head 15 to defect sector DS1, and performs defect scanning under Criteria-A.

Further, the defect detector 63 performs defect scanning in adjacent sector A12 under Criteria-A.

If a small defect is not detected under Criteria-A, the defect detector 63 changes determination criteria from Criteria-A to Criteria-B, and performs defect scanning again from adjacent sector A11 to adjacent sector A12.

If a small defect is not detected under Criteria-B, the defect detector 63 changes determination criteria from Criteria-B to Criteria-C, and performs defect scanning again from adjacent sector A11 to adjacent sector A12.

If a small defect is not detected under all criteria, for example, all criteria shown in table TA1, the defect detector 63 determines that none of defect sector DS1 and adjacent sectors A11 and A12 has a small defect.

As described above, the defect detector 63 performs defect scanning in order to detect a small defect in radially adjacent sectors. The defect detector 63 may also perform defect scanning for detecting a small defect on a plurality of sectors provided outside and inside a defect sector group. Although it is described for convenience that the defect detector 63 performs data scanning on each sector under the same determination criteria, it may perform data scanning on different sectors under different determination criteria. The defect detector 63 may repeat defect scanning with current determination criteria changed to subsequent determination criteria of higher detection sensitivity, until a small defect is detected in each sector.

In sequential sectors in one cylinder, the defect detector 63 changes the determination criteria for detecting a defect, when the head 15 reads a servo frame. When the head 15 reads the servo frame of a sector, the defect detector 63 may continue defect scanning using the same determination criteria.

Referring now to FIG. 4B, a description will be given of an example of periods in which the defect detector 63 changes determination criteria to execute defect scanning on cylinder Cyl.n−1.

For instance, as shown in FIG. 4B, the defect detector 63 applies determination Criteria (Def.) to sectors in cylinder Cyl.n−1, where no defect is detected. After the head 15 reads servo frame SRV1 of defect sector DS1 in a zone ranging from sector SC0 to sector SC1, the defect detector 63 applies Criteria-A in period T1.

Further, after the head 15 reads servo frame SRV2 in a zone ranging from sector SC1 to sector SC2, the defect detector 63 applies Criteria-B in period T2.

Furthermore, after the head 15 leads servo frame SRV3 in a zone ranging from sector SC2 to sector SC3, the defect detector 63 applies Criteria-C in period T3 to sectors SC3 and SC4.

As described above, the defect detector 63 changes determination criteria on one cylinder. Although in the above-mentioned time examples of changing the determination criteria, the defect detector 63 changes determination criteria sector by sector, for convenience of description, to perform defect scanning, it may execute defect scanning on one cylinder under the same determination criteria.

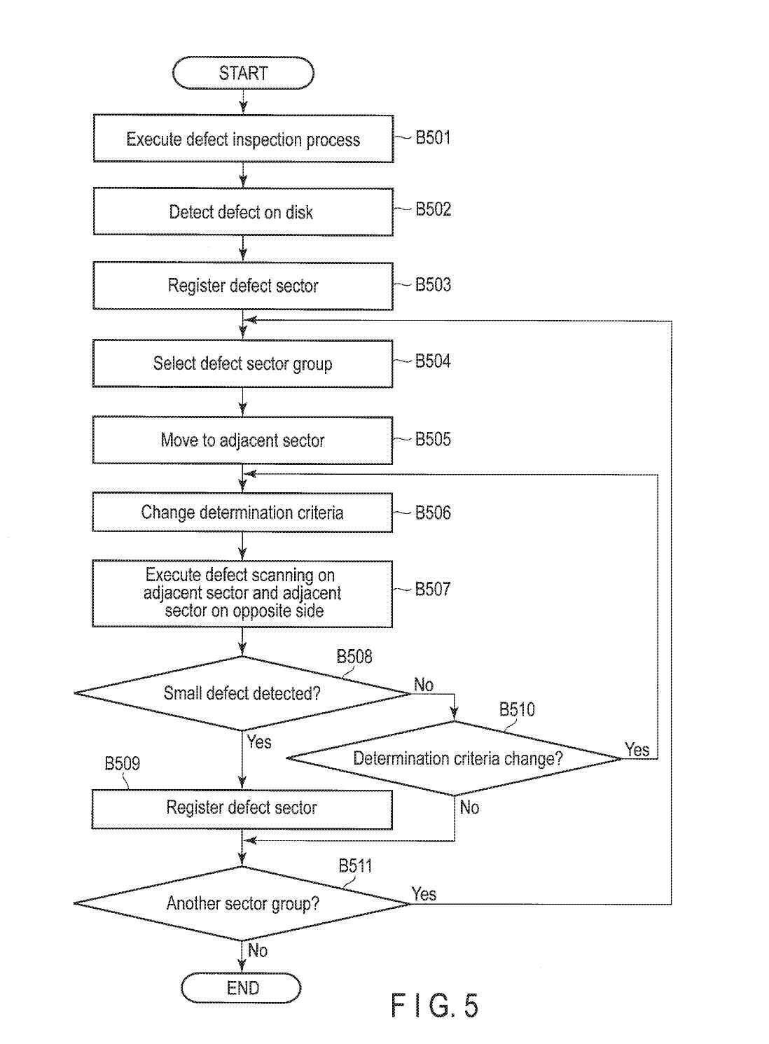

FIG. 5 is a flowchart showing a method of detecting a defect on the magnetic disk device 1 of the embodiment.

The MPU 60 performs a defect inspection process (B501).

The MPU 60 detects a defect on the disk 10 (B502), and registers, to the defect management list 110, the sector number, for example, of a defect sector having the defect (B503).

With reference to the defect management list 110, the MPU 60 selects a defect sector group (B504), and moves the head 15 to an adjacent sector adjoining the defect sector group (B505).

With reference to table TA1 showing determination criteria evaluated in advance, the MPU 60 changes current determination criteria to subsequent determination criteria including a higher detection sensitivity (B506).

The MPU 60 performs defect scanning on an adjacent sector, a defect sector group, and an opposite-side adjacent sector (B507), thereby determining whether a small defect is detected (B508).

If determining that a small defect is detected (YES in B508), the MPU 60 registers a sector with the small defect as a defect sector in the defect management list 110 (B509).

In contrast, if determining that a small defect is not detected (NO in B508), the MPU 60 determines whether the determination criteria for detecting a defect should be changed (B510).

If determining that the determination criteria for defect detection should be changed (YES in B510), the MPU 60 returns to B506. In contrast, if determining that the determination criteria for defect detection should not be changed (NO in B510), the MPU 60 determines whether there is another defect sector group, referring to the defect management list 110 (B511).

If determining that there is another defect sector group (YES in B511), the MPU 60 returns to B504. In contrast, if determining that there is no more defect sector group (NO in B511), the MPU 60 terminates this processing.

In the magnetic disk device 1 according to the embodiment, a small defect smaller than normal ones can be detected and is registered in the defect management list 110. This process can prevent in advance a sector from growing into a later-detected defect sector, because of a small defect contained therein, in a manufacturing process performed after a defect inspection process. Further, in the magnetic disk device 1, detection of a small defect can reduce the number of retries. Accordingly, the time required for a read/write test process for the magnetic disk device 1 can be reduced. As a result, the reliability of the magnetic disk device 1 improves.

Modifications of the magnetic disk device according to the first embodiment will now be described.

In the modifications, like elements are denoted by like reference numbers, and no detailed description will be given of the like elements.

(Modification 1)

In modification 1, the MPU 60 continues defect scanning as long as a small defect is detected. For instance, when a small defect is detected in a sector adjacent to a defect sector group, the MPU 60 performs defect scanning on the adjacent sector (first adjacent sector) where the small defect is detected, and also on a sector (second adjacent sector) adjacent to the first adjacent sector.

At this time, the MPU 60 registers the first adjacent sector, where the small defect is detected, as a defect sector in the defect management list. The MPU 60 also recognizes the first adjacent sector with the detected small defect as part of a defect sector group where defects are detected.

As long as a small defect is detected, the MPU 60 executes defect scanning on adjacent sectors located inside and outside of the adjacent sector where the small defect is detected.

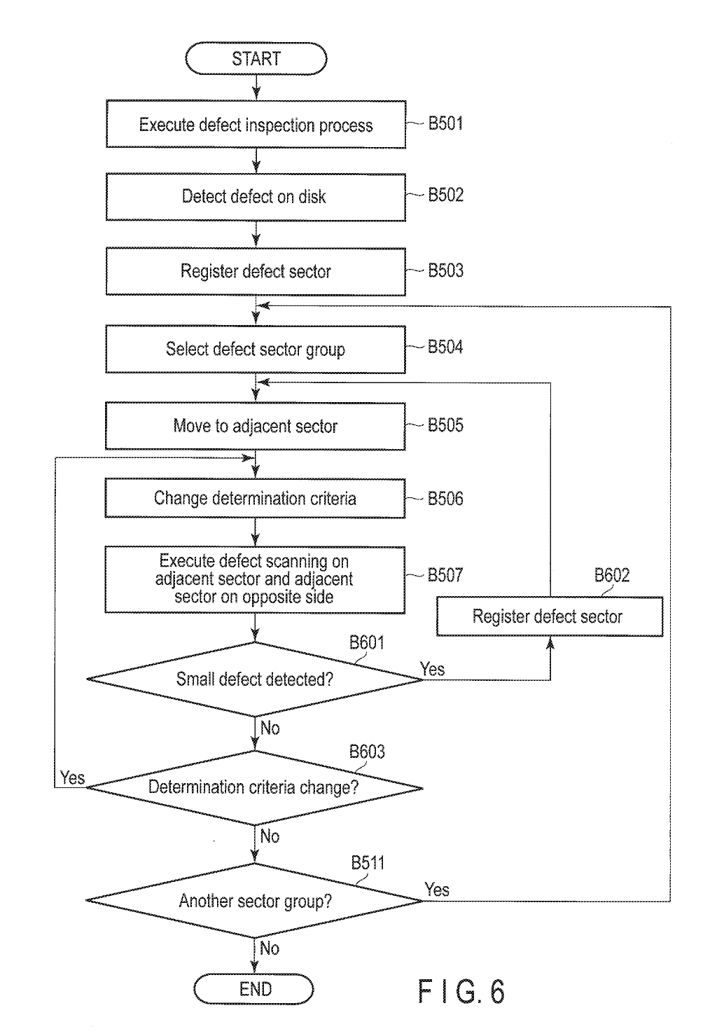

FIG. 6 is a flowchart showing a method of detecting a defect on a magnetic disk device 1 according to modification 1. In the flowchart of FIG. 6, steps equivalent to those of the flowchart of FIG. 5 are denoted by corresponding reference numbers, and no detailed description will be given thereof.

The MPU 60 executes an inspection process (B501).

The MPU 60 detects a defect on the disk 10 and registers a sector with the detected defect in the defect management list 110 (B502 to B503).

With reference to the defect management list 110, the MPU 60 selects a defect sector group and moves the head 15 to an adjacent sector that adjoins the defect sector group (B504 to B505).

The MPU 60 changes determination criteria and executes defect scanning on the adjacent sector, the defect sector group, and an opposite-side adjacent sector (B506 to B507). Subsequently, the MPU 60 determines whether a small defect is detected (B601).

If determining that a small defect is detected (YES in B601), the MPU 60 registers the sector, where the small defect is detected, as a defect sector in the defect management list 110 (B602). After B602, the MPU 60 returns to B505.

In contrast, if determining that a small defect is not detected (NO in B601), the MPU 60 determines whether determination criteria for defect detection should be changed (B603). If determining that determination criteria for defect detection should be changed (YES in B603), the MPU 60 returns to B506. If determining that determination criteria for defect detection should not be changed (NO in B603), the MPU 60 proceeds to B511.

According to modification 1, the magnetic disk device 1 can detect small defects in a wider range than in the above-described embodiment, and register them in the defect management list 110. As a result, the magnetic disk device 1 of modification 1 exhibits a higher reliability than the above-described embodiment.

(Modification 2)

In modification 2, if the MPU 60 detects a normal defect in the inspection process, it executes defect scanning of sectors around a sector (hereinafter, referred to as the center sector) where the defect is detected.

For example, the MPU 60 alternately executes defect scanning on sectors inside and outside the center sector. In this case, if no defect is detected by the defect scanning, the MPU 60 changes current determination criteria to subsequent determination criteria of a higher detection sensitivity.

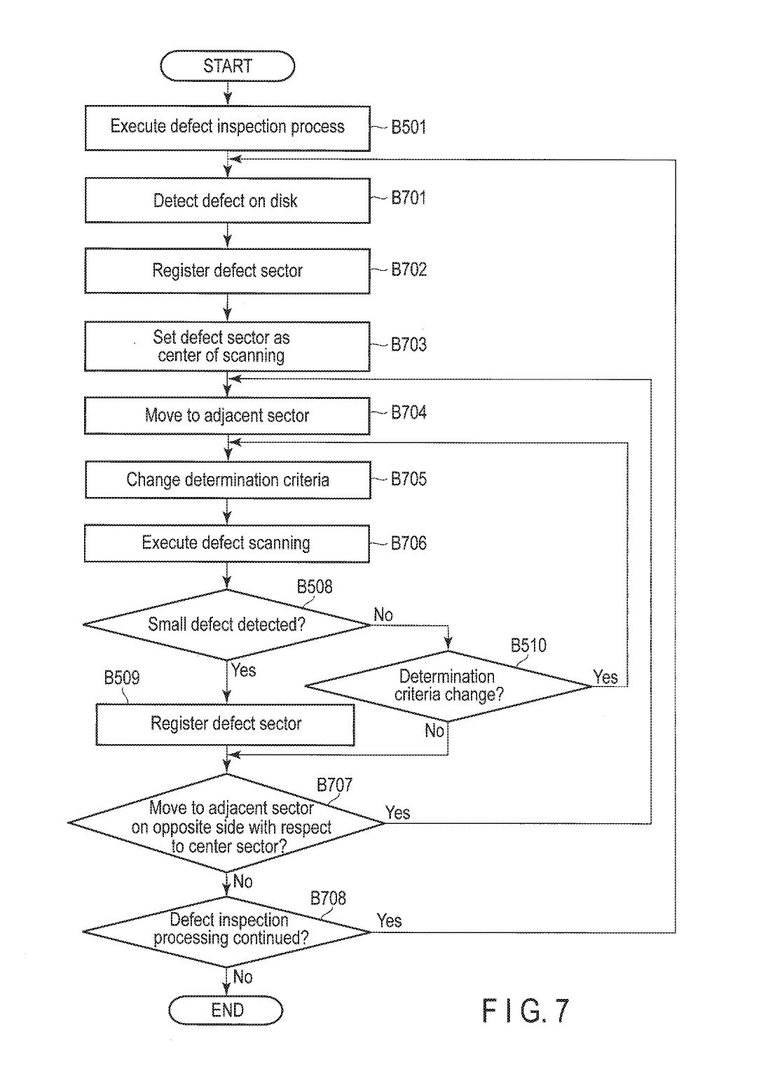

FIG. 7 is a flowchart showing a method of detecting a defect in the magnetic disk device 1 of modification 2. In the flowchart of FIG. 7, steps equivalent to those of the flowchart of FIG. 5 are denoted by corresponding reference numbers, and no detailed description will be given thereof.

The MPU 60 detects a normal defect (B701) by defect inspection process (B501), registers a sector with the detected defect as a defect sector in the defect management list 110 (B702).

The MPU 60 sets, as a center sector for defect scanning, a defect sector where a normal defect is detected (B703), and moves the head 15 to an adjacent sector that adjoins the center sector (B704). The adjacent sector may be any of the adjacent sectors located inside and outside the center sector.

With reference to table TA1 showing determination criteria evaluated in advance, the MPU 60 changes current determination criteria to subsequent determination criteria of a higher detection sensitivity (B705).

The MPU 60 executes defect scanning on an adjacent sector (B706), and then performs B508 to B510.

The MPU 60 determines whether to move the head to an opposite adjacent sector with respect to the center sector (B707). If determining that the head should be moved to the opposite adjacent sector (YES in B707), the MPU 60 returns to B705. In contrast, if determining that the head should not be moved to the opposite adjacent sector (NO in B707), the MPU 60 determines whether the inspection process should be continued (B708).

If determining that the inspection process should be continued (YES in B708), the MPU 60 returns to B704. In contrast, if determining that the inspection process should not be continued (NO in B708), the MPU 60 terminates this processing.

According to this modification, the magnetic disk device 1 can detect a small defect during the inspection process, thereby registering it in the defect management list 110. This means that the magnetic disk device 1 does not have to employ an additional process for detecting a small defect, and therefore that the time required for manufacturing the device can be more reduced than in the above-described embodiment.

The MPU 60 may execute defect scanning toward the outside or inside with respect to the central sector, until detecting a small defect under particular determination criteria. If no defect could be detected by this defect scanning, the MPU 60 changes current determination criteria to subsequent determination criteria of a higher detection sensitivity, and re-executes defect scanning toward the outside or inside with respect to the central sector. The MPU 60 may repeat, until detecting a small defect, the defect scanning toward the outside or inside with respect to the central sector while changing the determination criteria.

(Modification 3)

In modification 3, upon detecting a defect, the MPU 60 executes defect scanning, for detecting a small defect, on sectors located circumferentially immediately before and after a sector where the defect is detected.

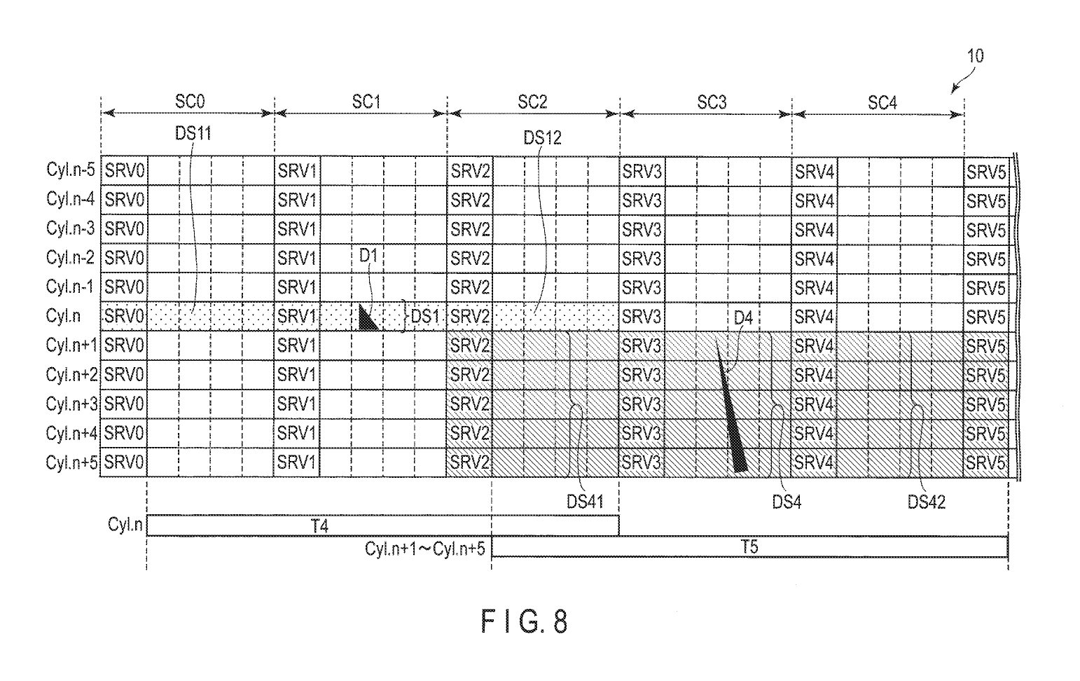

FIG. 8 shows examples of periods in which determination criteria for detecting a defect are changed.

In FIG. 8, D4 denotes a normal defect detected in the inspection process. Defect D4 is formed in sectors SC3 ranging from cylinder Cyl.n+1 to cylinder Cyl.n+5. A plurality of sectors SC3 ranging from cylinder Cyl.n+1 to cylinder Cyl.n+5, where defect D4 is detected, will hereinafter be referred to as defect sector group DS4.

Sector DS11 is a sector SC1 of cylinder Cyl.n. Sector DS11 adjoins the circumferential front end of defect sector DS1. That is, sector DS11 is sector SC0 of cylinder Cyl.n. Sector DS12 adjoins the circumferential rear end of defect sector DS1. That is, sector DS12 is sector SC2 of cylinder Cyl.n.

Sector group DS41 includes respective sectors SC2 of cylinders Cyl.n+1 to Cyln+5. Sector group DS41 adjoins the circumferential front end of defect sector group DS4. Sector group DS42 includes respective sectors SC4 of cylinders Cyl.n+1 to Cyln+5. Sector group DS42 adjoins the circumferential rear end of defect sector group DS4.

In FIG. 8, T4 denotes a period in which determination criteria should be changed in sector DS11, defect sector DS1 and sector DS12, and T5 denotes a period in which determination criteria should be changed in sector group DS41, defect sector group DS4, and sector group DS42.

After detecting a normal defect in the inspection process, the defect detector 63 changes determination criteria in a sector group that adjoins the circumferential front and rear ends of a defect sector group, and executes defect scanning for detecting a small defect.

A description will be given of an example of a method of executing defect scanning for detecting a small defect in circumferentially adjacent sectors in FIG. 8.

For example, in FIG. 8, in sector DS11, the defect detector 63 changes determination criteria from Criteria (Def.) to Criteria-A, thereby executing defect scanning. Also in defect sector DS1 and sector DS12, the defect detector 63 performs defect scanning under Criteria-A.

If no small defect is detected under Criteria-A, the defect detector 63 changes determination criteria from Criteria-A to Criteria-B, and performs defect scanning from sector DS11 to sector DS12.

If no small defect is detected under Criteria-B, the defect detector 63 changes determination criteria from Criteria-B to Criteria-C, and performs defect scanning from sector DS11 to sector DS12.

If a small defect is not detected under all criteria, for example, all criteria shown in table TA1, the defect detector 63 determines that none of defect sector DS1 and sectors DS11 and DS12 has a small defect.

As described above, the defect detector 63 performs defect scanning for detecting a small defect on circumferentially adjacent sectors. The defect detector 63 may also perform defect scanning for detecting a small defect on a plurality of sectors located circumferentially immediately before and after a defect sector group. Further, although it is described for convenience sake that the defect detector 63 executes data scanning on each sector under the same determination criteria, it may execute data scanning under different determination criteria sector by sector.

A description will now be given of an example of a period in which the defect detector 63 changes determination criteria when executing defect scanning on cylinder Cyl.n in FIG. 8.

For example, as shown in FIG. 8, the defect detector 63 applies determination Criteria (Def.) to a sector in Cyl.n where no defect is detected.

In a zone from sector SC0 to sector SC2, the defect detector 63 applies Criteria-A in period T4 after the head 15 reads servo frame SRV0 of sector DS11.

According to modification 3, the magnetic disk device 1 can detect a small defect in a sector circumferentially adjacent to a defect sector, and can register it in the defect management list 110. Thus, the magnetic disk device 1 of this modification exhibits a higher reliability than the above-mentioned embodiment.

A magnetic disk device and measuring method according to a second embodiment will then be described. In the second embodiment, elements similar to those of the above-described embodiment are denoted by corresponding reference numbers, and no detailed description will be given thereof.

### Second Embodiment

In the second embodiment, the MPU 60 registers, as a later-detected defect sector in the defect management list 110, a sector recovered after shipping by more than a particular number of reties during read/write processing in a user model. For instance, the MPU 60 registers such a sector as a later-detected defect sector in the G list of defect management list 110. The MPU 60 replaces the later-detected defect sector with a normal substitution sector. The MPU 60 executes defect scanning on sectors around the later-detected defect sector, in order to detect a small defect.

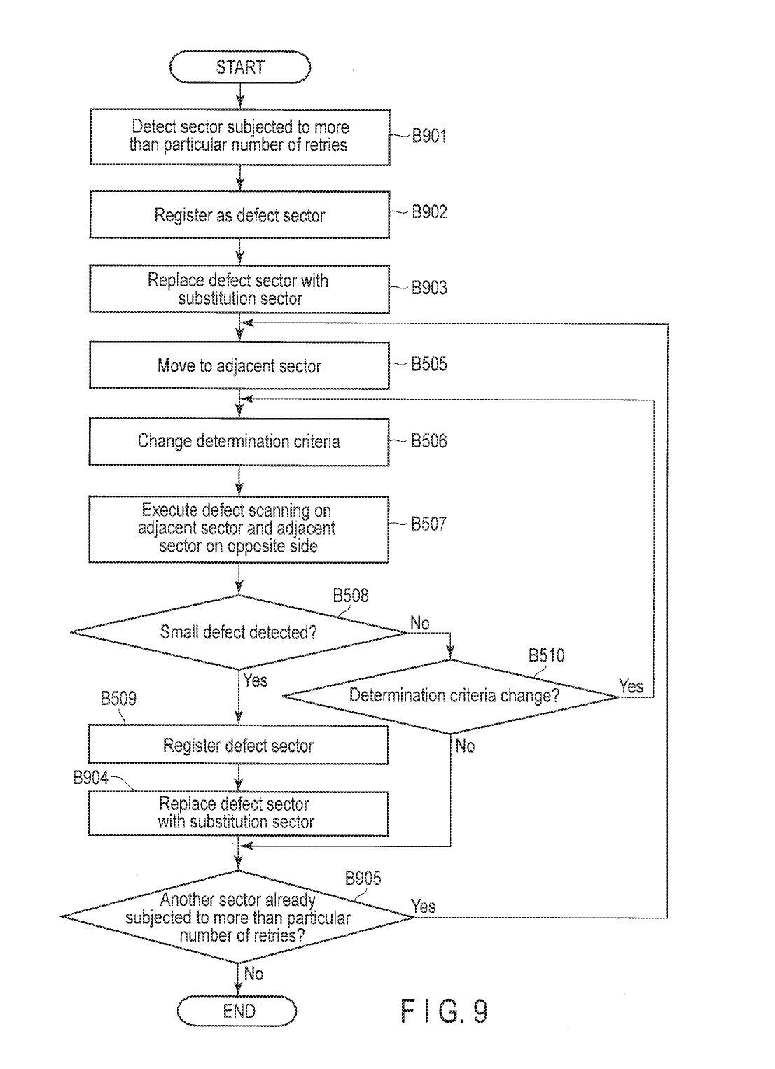

FIG. 9 is a flowchart showing a method of detecting a defect in the magnetic disk device 1 of the second embodiment. In the flowchart of FIG. 9, steps similar to those of the flowchart of FIG. 5 are denoted by corresponding reference numbers, and no detailed description will be given thereof.

The MPU 60 detects a sector that has been subjected to more than a particular number of retries (B901), and registers the detected sector in the defect management list 110 as a later-detected defect sector (B902).

The MPU 60 replaces the later-detected defect sector with a substitution sector (B903). Subsequently, the MPU 60 executes B505 to B510. At this time, if detecting a small defect, the MPU 60 registers a sector with the small defect in the defect management list 110 (B508 to B509). In contrast, if detecting no small defect, the MPU determines whether to change the determination criteria for detecting a defect (B508 to B510).

After B509, the MPU 60 replaces the later-detected defect sector, where the small defect is detected, with a substitution sector (B904).

The MPU 60 determines whether there is another sector that has been subjected to more than the particular number of retries (B905). It determining that there is another sector that has been subjected to more than the particular number of retries (YES in B905), the MPU 60 returns to B505. In contrast, if determining that there is no more sector that has been subjected to the particular number of retries (NO in B905), the MPU 60 finishes the processing.

In the second embodiment, the magnetic disk device 1, after shipment, can detect a small defect around a sector recovered during read/write processing by the particular number of retries, and can register it in the defect management list 110. Therefore, when a later-detected defect has occurred because of, for example, an impact or vibration under a user-use environment after shipping, a sector where the defect occurs in the front or rear portion of the sector can be replaced in a preventive manner. Thus, occurrence of a defect or bad sector can be suppressed in the magnetic disk device under the user-use environment.

While a certain embodiment has been described, the embodiment has been presented by way of example only, and is not intended to limit the scope of the invention. Indeed, the novel embodiment described herein may be embodied in a variety of other forms; furthermore, various omissions, substitutions and changes in the form of the embodiment described herein may be made without departing from the spirit of the invention. The accompanying claims and their equivalents are intended to cover such forms or modifications as would fall within the scope and spirit of the inventions.

What is claimed is:

1. A magnetic disk device comprising:
a disk including a data area;
a head configured to read and write data from and to the data area;
a controller configured to determine under a first condition whether the data area includes a defect, and to determine, under a second condition of a higher defect detection sensitivity than the first condition, whether a first area around a first defect area includes a defect, when detecting the first defect area under the first condition.

2. The magnetic disk device of claim 1, wherein when detecting no defect under the second condition, the controller determines, under a third condition of a higher defect detection sensitivity than the second condition, whether the first area includes a defect.

3. The magnetic disk device of claim 2, wherein when detecting no defect under the third condition, the controller changes, until detecting a defect, a current condition to a subsequent condition of a defect detection sensitivity higher than a defect detection sensitivity of the current condition, and causes the head to scan the first area whenever changing the current condition to the subsequent condition.

4. The magnetic disk device of claim 1, wherein
the controller reads a signal of a particular pattern from the data area;
determines that a data area is the first defect area, when a signal of the particular pattern read from the data area has an amplitude exceeding a first threshold associated with an amplitude included in the first condition; and
determines that a first area is a second defect area, when a signal of the particular pattern read from the first area has an amplitude exceeding a second threshold associated with an amplitude included in the second condition.

5. The magnetic disk device of claim 4, wherein the controller scans, using the head, a first adjacent area radially adjacent to the first defect area, determines, when detecting that an amplitude exceeds the second threshold, that the first adjacent area is the second defect area, and registers the first adjacent area as the second defect area.

6. The magnetic disk device of claim 5, wherein the controller scans, using the head, a second adjacent area radially adjacent to the second defect area, determines, when detecting that an amplitude associated with the second adjacent exceeds the second threshold, that the second adjacent area is the second defect area, and registers the second adjacent area as the second defect area.

7. The magnetic disk device of claim 4, wherein the controller scans, using the head, a first adjacent area circumferentially adjacent to the first defect area, determines, when detecting that an amplitude associated with the first adjacent area exceeds the second threshold, that the first adjacent area is the second defect area, and registers the first adjacent area as the second defect area.

8. The magnetic disk device of claim 4, wherein
the controller scans, using the head, a first adjacent area circumferentially adjacent to the first defect area, determines, when detecting that an amplitude associated with the first adjacent area exceeds the second threshold, that the first adjacent area is the second defect area, and registers the first adjacent area as the second defect area, and wherein the controller further
scans, using the head, a second adjacent area circumferentially adjacent to the first defect area on an opposite side of the first adjacent area, determines, when detecting that an amplitude associated with the second adjacent area exceeds the second threshold, that the second adjacent area is the second defect area, and registers the second adjacent area as the second defect area.

9. The magnetic disk device of claim 5, wherein
the controller registers, as a third defect area, part of the data area other than the first and second defect areas, a particular number or more of read retries having being performed by the head in the part of the data area;
causes the head to scan a second area around the data area surrounding the third defect area; and
registers, as the second defect area, a first data area included in the second area, when an amplitude associated with the first data area exceeds the second threshold.

10. The magnetic disk device of claim 9, wherein when performing a read and a write by the head, the controller causes the second and third defect areas to correspond to substitution areas for the data area.

11. A defect detection method for use in a magnetic disk device comprising a disk including a data area, and a head configured to read and write data from and to the data area, the method comprising:
determining under a first condition whether the data area includes a defect; and
determining, under a second condition of a higher defect detection sensitivity than the first condition, whether a first area around a first defect area includes a defect, when detecting the first defect area under the first condition.

12. The defect detection method of claim 11, wherein when detecting no defect under the second condition, it is determined, under a third condition of a higher defect detection sensitivity than the second condition, whether the first area includes a defect.

13. The defect detection method of claim 12, wherein when detecting no defect under the third condition, changing, until detecting a defect, a current condition to a subsequent condition of a defect detection sensitivity higher than a defect detection sensitivity of the current condition; and
causing the head to scanning the first area whenever changing the current condition to the subsequent condition.

14. The defect detection method of claim 11, further comprising:
reading a signal of a particular pattern from the data area;
determining that a data area is the first defect area, when a signal of the particular pattern read from the data area has an amplitude exceeding a first threshold associated with an amplitude included in the first condition; and
determining that a first area is a second defect area, when a signal of the particular pattern read from the first area has an amplitude exceeding a second threshold associated with an amplitude included in the second condition.

15. The defect detection method of claim 14, further comprising:
scanning, using the head, a first adjacent area radially adjacent to the first defect area;
determining that the first adjacent area is the second defect area, when detecting that an amplitude exceeds the second threshold; and
registering the first adjacent area as the second defect area.

16. The defect detection method of claim 15, further comprising:
scanning, using the head, a second adjacent area radially adjacent to the second defect area;
determining that the second adjacent area is the second defect area, when detecting that an amplitude associated with the second adjacent area exceeds the second threshold; and
registering the second adjacent area as the second defect area.

17. The defect detection method of claim 14, further comprising:
scanning, using the head, a first adjacent area circumferentially adjacent to the first defect area;
determining that the first adjacent area is the second defect area, when detecting that an amplitude associated with the first adjacent area exceeds the second threshold; and
registering the first adjacent area as the second defect area.

18. The defect detection method of claim 14, further comprising:
scanning, using the head, a first adjacent area circumferentially adjacent to the first defect area;
determining that the first adjacent area is the second defect area, when detecting that an amplitude associated with the first adjacent area exceeds the second threshold;
registering the first adjacent area as the second defect area;
further scanning, using the head, a second adjacent area circumferentially adjacent to the first defect area on an opposite side of the first adjacent area;
determining that the second adjacent area is the second defect area, when detecting that an amplitude associated with the second adjacent area exceeds the second threshold; and
registering the second adjacent area as the second defect area.

19. The defect detection method of claim 15, further comprising:
registering, as a third defect area, part of the data area other than the first and second defect areas, a particular number or more of read retries having being performed by the head in the part of the data area;
scanning, using the head, a second area around the data area surrounding the third defect area; and
registering, as the second defect area, a first data area included in the second area, when an amplitude associated with the first data area exceeds the second threshold.

20. The defect detection method of claim 19, wherein when performing a read and a write by the head, causing the second and third defect areas to correspond to substitution areas for the data area.
